(19) United States
(12) Patent Application Publication
(10) Pub. No.: US 2022/0358948 A1
(43) Pub. Date: Nov. 10, 2022

(54) SELF-ACTIVATED SPEECH ENHANCEMENT

(71) Applicant: Waves Audio Ltd., Tel Aviv (IL)

(72) Inventors: Ahikam Lavi, Kiryat Ono (IL); Nahum Noam Weissman, Giv'at Shmuel (IL); Yoav Moshe Rattner, Herzliya (US)

(21) Appl. No.: 17/734,131

(22) Filed: May 2, 2022

(30) Foreign Application Priority Data
May 5, 2021 (GB) 2106390.4

(51) Int. Cl. G10L 21/0364; G10L 25/78; G10L 21/0224; G10L 21/034; G10L 21/0232

(52) U.S. Cl. CPC G10L 21/0364; G10L 25/78; G10L 21/0224; G10L 21/034; G10L 21/0232

(57) ABSTRACT

An audio input configured to input an audio stream and a noise reduction module configured for processing the audio stream for emphasizing speech content. A monophonic detector is configured to determine whether the audio stream is either monophonic or not monophonic. A decision module is configured to receive an input from the monophonic detector and to output a decision to bypass the noise-reduction when the audio stream is not monophonic.

### BACKGROUND

### 1. Technical Field

The present invention relates to noise reduction and particularly to speech enhancement during an audio conference.

### 2. Description of Related Art

Voice over Internet Protocol (VoIP) communication includes encoding voice as digital data, encapsulating the digital data into data packets, and transporting the data packets over a data network. A conference call is a telephone call between two or more participants at geographically distributed locations, which allows each participant to be able to speak to, and to listen to, other participants simultaneously. A conference call among the participants may be conducted via a voice conference bridge or centralized server. The conference call connects multiple endpoint devices (VoIP devices or computer systems) associated with the participants using appropriate Web conference communication protocols. Alternatively, conference calls may be mediated peer-to-peer in which audio may be streamed directly between participants' computer systems without an intermediary server.

US patent publication U.S. Pat. No. 5,210,796 discloses a stereo/monophonic detection apparatus for detecting whether two-channel input audio signals are stereo or monophonic. The level difference between the input audio signals is calculated. The signal representing the level difference is discriminated maintaining a predetermined hysteresis. A stereo/monophonic detection is performed in accordance with the result of the discrimination to prevent an erroneous detection that may otherwise be caused by a level difference variation during a short time as in a case where the sound field is positioned at the center in the stereo signals.

### BRIEF SUMMARY

Various computerized systems and methods are disclosed herein including an audio input configured to input an audio stream and a processor configured to enable noise reduction and process the audio stream for emphasizing speech content. A monophonic detector is configured to determine whether the audio stream is either monophonic or not monophonic. A decision module is configured to receive an input from the monophonic detector and to output a decision to bypass the noise-reduction when the audio stream is not monophonic. A speech detection module may be configured to detect speech in the audio stream and maintain bypass of the noise reduction until speech is detected in the audio stream. The processor may be configured to apply the noise reduction when the audio stream is monophonic and when speech is detected in the audio stream. The noise-reduction may be bypassed while starting input of the audio stream. The processor may be configured to parse the audio stream into audio frames. The processor may be configured to bypass the noise reduction when a current audio frame is not monophonic. The processor may be configured to enable noise reduction by computing time-frequency gains for emphasizing speech content in the audio stream. The processor may be configured to monitor the audio frames for speech, update a status of the audio stream as including speech when a number greater than a threshold of, e.g. consecutive, audio frames are detected as including speech. The noise reduction for emphasizing the speech content may be applied when the status is updated. However, when less than a threshold of audio frames are detected as including speech, noise reduction may not be applied but time-frequency gains may be computed and stored for later noise reduction during upcoming frames. The processor may be configured to maintain the noise reduction until end of the audio stream unless the audio stream is determined not to be monophonic. The processor may be configured to transform the audio stream into a time-frequency representation, compute time-frequency gains configured to emphasize speech content in the audio stream and inverse-transform the time-frequency representation to time domain while applying the time-frequency gains to produce an audio stream with emphasized speech content.

Various computer readable media are disclosed, that, when executed by a processor, cause the processor to execute methods disclosed herein.

### BRIEF DESCRIPTION OF THE DRAWINGS

The invention is herein described, by way of example only, with reference to the accompanying drawings, wherein:

FIG. 1 illustrates a simplified schematic block diagram of a processor, according to features of the present invention;

FIG. 2, illustrates a flow diagram of a method according to features of the present invention; and

FIG. 3 illustrates a continuation of the flow diagram of FIG. 2.

The foregoing and/or other aspects will become apparent from the following detailed description when considered in conjunction with the accompanying drawing figures.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

By way of introduction, aspects of the present invention are directed to communications of speech audio signals, using Voice over Internet Protocol (VoIP) communications by way of example. Noise reduction, also known as speech emphasis or speech enhancement, for VoIP communications is intended to enhance human speech and/or reduce audio content other than human speech. However, noise reduction algorithms may also reduce desired audio content which is not related to human speech. Examples include a ringtone beginning a call, or an audible notification received during a conference. Other examples may include a music lesson over VoIP or desired audio content played during an online conference. Embodiments of the present invention are directed to applying noise reduction when there is speech and otherwise bypassing the noise reduction when audio content other than speech is communicated in order not to remove or reduce desired audio content during the conference.

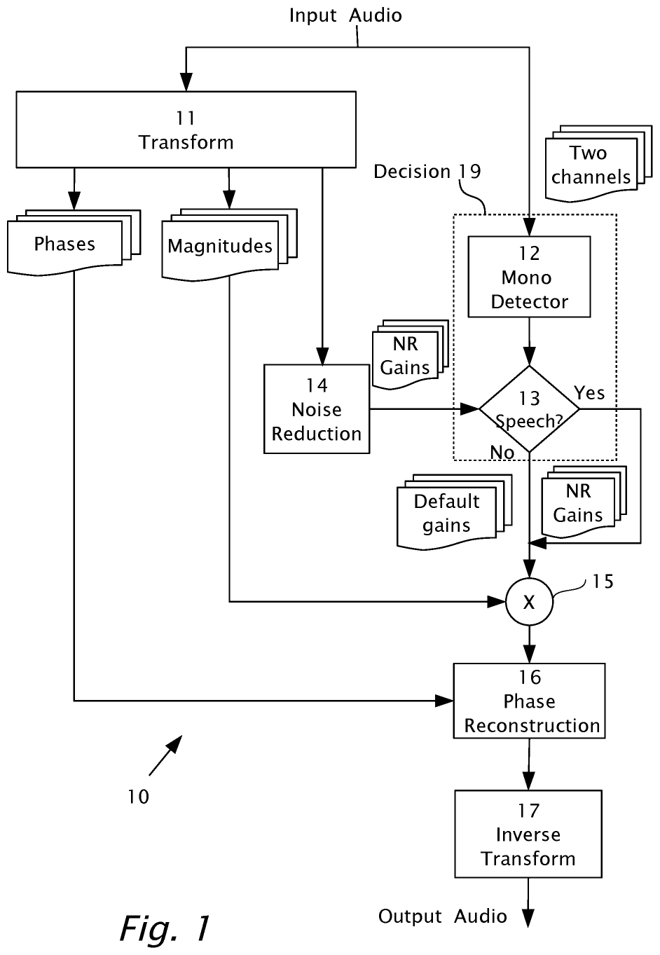

Referring now to the drawings, reference is now made to FIG. 1, a simplified schematic block diagram of a processor 10, according to features of the present invention. Input audio, e.g. two channels of stereo, may be input to a decision module 19. Decision module 19 includes a monophonic detector 12 configured to compare or correlate the two channels of input audio and detect whether the two channels are similar or identical, i.e. monophonic input audio, or dissimilar channels of input audio, i.e. stereo input audio. A monophonic input audio signal is indicative of speech. A stereo input audio signal is indicative of content other than speech, e.g. music. Decision module 19 may include a voice activity detector or speech detector 13 which may receive an input from monophonic detector 12.

In parallel, one or more channels of input audio may be input to transform module 11 configured to perform a time-frequency transform, e.g. short time Fourier transform (STFT). The time-frequency transform, e.g. STFT, may be input to a noise reduction module 14 configured to output noise reduction (NR) gains. Noise reduction module 14 may estimate the noise reduction (NR) gains without applying the reduction operation. NR gains may be input to decision module 19. Decision module 19 may select between NR gains which may be appropriate when the audio signal includes speech and default gains which may be appropriate for audio content other than speech. Gains selected by decision module 19 may be combined or multiplied (block 15) by magnitudes determined from the time-frequency transform, e.g. STFT. Complex coefficients or phases may be retrieved or reconstructed in block 16 from phase information from STFT transform 11. Inverse transform module 17 may inverse transform into time domain output audio either with noise reduction gains or default gains depending on the selection of decision module 19 whether input audio includes speech content. Default gains may be unity gains or may include filtering, equalization et cetera dependent on characteristics of the non-speech audio being processed.

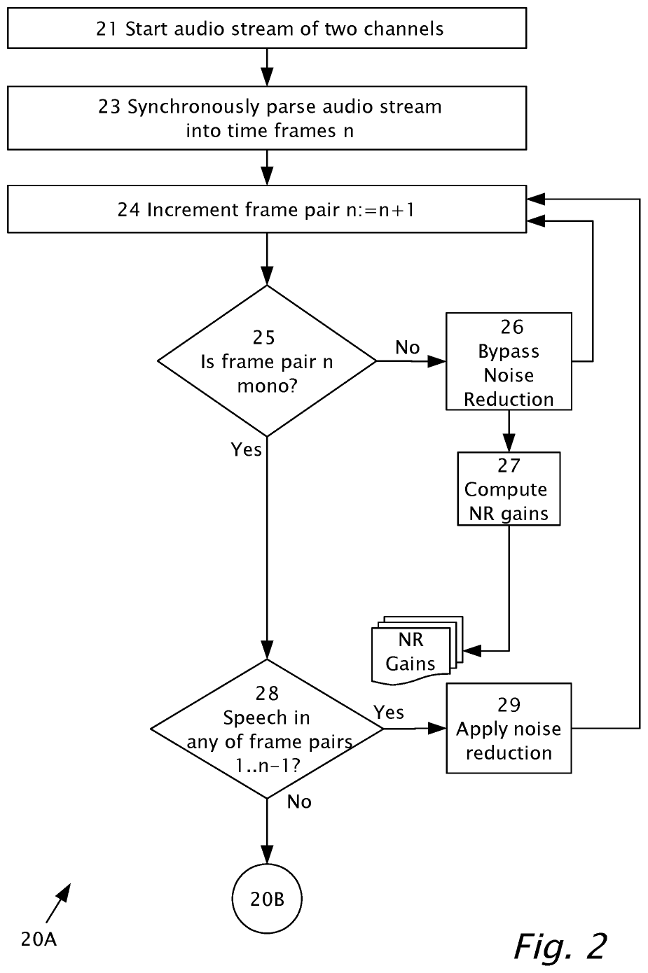

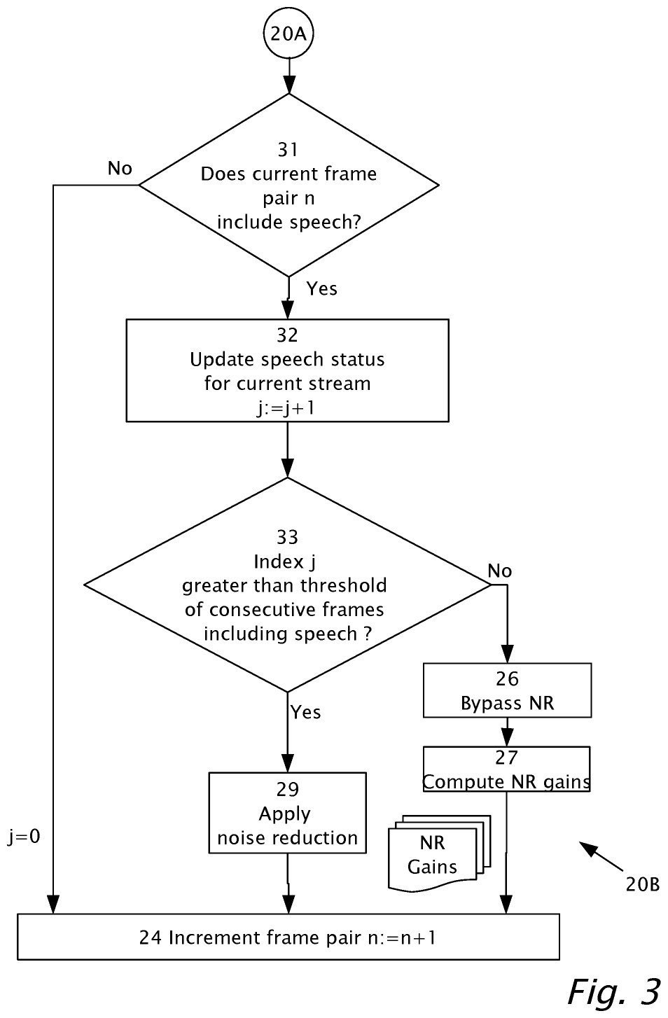

Reference is now also made to FIG. 2, illustrating a flow diagram 20A of a method according to features of the present invention which continues with flow diagram 20B illustrated as FIG. 3. Two channels of audio may start streaming. (step 21) Noise reduction functionality (NR) may be bypassed during start (step 21) of audio stream by default. The two channels of audio stream may be synchronously parsed (step 23) into multiple synchronous paired audio frames n. Synchronous paired frames n are monitored for similarity (block 12, FIG. 1) and if not monophonic (decision 25), for instance synchronous paired frames n are part of a stereo audio stream, then noise reduction is bypassed (or continues to be bypassed) in step 26 and audio frame pair is incremented (step 24). In addition, noise reduction (NR) gains may be computed (step 27) enabling noise reduction in upcoming frame pairs. Otherwise, in decision 25, if frame pair n is monophonic, then in decision 28, if speech was detected in previous frame pairs 1 . . . n−1, then noise reduction is applied (step 29) and frame pair is incremented. (step 24) It is noteworthy that at decision block 25, the decision branching may not be symmetric. A single audio frame pair may be detected as not monophonic, e.g. stereo, and noise reduction may be disabled or bypassed (step 26). However, before applying noise reduction (step 29) a number of consecutive audio frame pairs may be detected as monophonic or speech may be detected in a number of consecutive audio frame pairs. (FIG. 3)

Reference is now also made to FIG. 3 which illustrates continuation 20B of method 20, according to further features of the present invention. In decision 28 (FIG. 2) if speech was not detected in previous frame pairs 1 . . . n−1, then in decision 31, if current frame pair n does not include speech, then frame pair n may be incremented (step 24, method 20A, FIG. 2). Otherwise, in decision 31, if current frame pair n includes speech, then speech status for the current stream may be updated (step 32), i.e. incremented using index j the number of consecutive frame pairs including speech. In decision 33, if integer j of consecutive frame pairs is greater than a threshold then noise reduction is applied. (step 29). Otherwise, if integer j of consecutive frame pairs is not greater than a threshold, noise reduction may be bypassed (step 26), and noise reduction (NR) gains may be computed (step 27) enabling noise reduction during upcoming frame pairs n and frame pair n may be incremented (step 24, method 20A, FIG. 2). Alternatively, decision 33 whether to apply noise reduction 29 or to bypass noise reduction 26, may be determined, by way of example, based on multiple past frames with more weight given to the latest frames; or decision 33 may be based on a threshold rate of frames detected including speech, e.g. 90% of the previous thirty frames,

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone, a laptop computer or tablet where internal modules (such as a memory and processor) work together to perform operations on electronic data.

In this description and in the following claims, a “network” is defined as any architecture where two or more computer systems may exchange data. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The various aspects, embodiments, implementations or features of the described embodiments can be used separately or in any combination. Various aspects of the described embodiments can be implemented by software, hardware or a combination of hardware and software.

The term “audio frame” as used herein refers to an analogue audio signal which may include speech which is sampled and digitized. Sampling rate may be 45 kilohertz by way of example. The sampled speech signal may be parsed into audio frames usually of equal duration, 50 milliseconds by way of example.

The terms “mono” and “monophonic are used herein interchangeably and refer to an audio stream recorded with a single microphone or multiple audio streams recorded simultaneously with respective multiple microphones which are measurably identical within previously determined thresholds of time-frequency magnitudes and phases, except for an overall level adjustment between the multiple audio streams.

The terms “stereo” and “stereophonic” are used herein interchangeably and refer to multiple, e.g. two, audio streams recorded simultaneously with respective multiple, e.g. two, microphones which are measurably different, with differences greater than previously determined thresholds of time-frequency magnitudes and/or phases, except for overall levels.

The term “speech” as used herein includes conversation, voice and/or vocal content such as singing. The terms “speech content” and “vocal content” are used herein interchangeably.

The term “detecting speech” as used herein is sometimes known as “voice activity detection” (VAD) and refers to a binary decision of whether one or more audio frames includes speech or does not include speech. Voice activity detection (VAD) may be performed by first determining a speech presence probability in the audio frame and subsequently based on a previously defined threshold deciding whether or not the audio frame includes speech.

The term “time-frequency” as in time-frequency analysis or time-frequency representation refers to techniques that analyze a signal in both the time and frequency domains simultaneously. A short time Fourier transform (STFT) is an example of a time-frequency representation.

The term “threshold” as used herein referring to multiple audio frames including speech content may be (but is not limited to) a consecutive number of frames or stereophonic frame pairs including speech, a fraction of previous audio frames including speech and/or a weighted fraction of audio frames including speech with greater weights on last frames, by way of example.

The term “gains” as used herein in the context of time-frequency gains refers to frequency dependent coefficients which may be real-valued and normalized between zero and one. The term “noise reduction (NR) gains” as used herein are frequency dependent coefficients computed to enhance speech and/or reduce audio signal or noise other than speech.

The transitional term “comprising” as used herein is synonymous with “including”, and is inclusive or open-ended and does not exclude additional, unrecited elements or method steps. The articles “a”, “an” is used herein, such as “a computer system”, “an audio frame” have the meaning of “one or more” that is “one or more computer systems”, “one or more audio frames”.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

Although selected features of the present invention have been shown and described, it is to be understood the present invention is not limited to the described features.

Although selected embodiments of the present invention have been shown and described, it is to be understood the present invention is not limited to the described embodiments. Instead, it is to be appreciated that changes may be made to these embodiments without departing from the scope of invention defined by the claims and the equivalents thereof.

The claimed invention is:

1. A computerized method comprising:
inputting an audio stream;
enabling noise reduction of the audio stream for emphasizing speech content in the audio stream; and
upon determining that the audio stream is not monophonic, bypassing the noise-reduction.

2. The computerized method of claim 1, further comprising:
bypassing the noise-reduction while starting said inputting of the audio stream.

3. The computerized method of claim 1, further comprising:
maintaining said bypassing of the noise reduction until speech is detected in the audio stream.

4. The computerized method of claim 1, further comprising:
upon detecting speech in the audio stream, applying the noise reduction.

5. The computerized method of claim 1, further comprising:
parsing the audio stream into audio frames.

6. The computerized method of claim 5, further comprising:
said bypassing the noise reduction when a current audio frame is not monophonic.

7. The computerized method of claim 5, further comprising:
said applying the noise reduction when a current audio frame is monophonic and when an audio frame of the audio stream includes speech.

8. The computerized method of claim 7, further comprising:
when a current audio frame of the audio stream includes speech and upon detecting in the audio stream a number greater than a threshold of audio frames as including speech, said applying the noise reduction for emphasizing the speech content.

9. The computerized method of claim 1, further comprising:
upon said applying the noise reduction, maintaining the noise reduction until end of the audio stream unless the audio stream is determined not to be monophonic.

10. The computerized method of claim 1, wherein the noise reduction processing includes:
transforming the audio stream into a time-frequency representation;
wherein the noise reduction includes processing the time-frequency representation of the audio stream by computing a plurality of time-frequency gains configured to emphasize speech content in the audio stream; and
inverse-transforming the time-frequency representation to time domain while applying the time-frequency gains, producing thereby an audio stream with emphasized speech content.

11. The computerized method of claim 10, wherein said enabling noise reduction includes said computing of the time-frequency gains configured to emphasize speech content in the audio stream.

12. The computerized method of claim 10, further comprising:
parsing the audio stream into audio frames;
monitoring the audio frames for speech;
updating a status of the audio stream as including speech when a number greater than a threshold of audio frames are detected as including speech;
upon said updating status of the audio stream as including speech, said applying the noise reduction.

13. The computerized method of claim 12, further comprising:
when less than a threshold of audio frames are detected as including speech:
(i) not applying noise reduction, and
(ii) computing time-frequency gains for noise reduction during upcoming frames.

14. A non-transitory computer readable medium storing instructions for executing a computerized method of claim 1.

15. A computerized system comprising:
an audio input configured to input an audio stream;
a processor configured for processing the audio stream;
the processor including:
a noise reduction module configured to emphasize speech content by noise reduction;
a monophonic detector configured to determine whether the audio stream is either monophonic or not monophonic; and
a decision module configured to receive an input from the monophonic detector and configured to output a decision to bypass the noise-reduction when the audio stream is not monophonic.

16. The computerized system of claim 15, further comprising:
a speech detection module configured to detect speech in the audio stream, wherein the processor is configured to apply the noise reduction when the audio stream is monophonic and when speech is detected in the audio stream.

17. The computerized system of claim 15, wherein the processor is configured to parse the audio stream into audio frames.

18. The computerized system of claim 17, wherein the processor is further configured to:
monitor the audio frames for speech;
update a status of the audio stream as including speech when a number greater than a threshold of audio frames are detected as including speech;
apply the noise reduction for emphasizing the speech content when the status is updated.

19. The computerized system of claim 17, wherein the processor is further configured to maintain the noise reduction until end of the audio stream unless the audio stream is determined not to be monophonic.

20. The computerized system of claim 15, wherein the processor is configured to:
transform the audio stream into a time-frequency representation;
compute a plurality of time-frequency gains configured to emphasize speech content in the audio stream; and
inverse-transform the time-frequency representation to time domain while applying the time-frequency gains and to produce an audio stream with emphasized speech content.
